(19) United States
(12) Patent Application Publication
(10) Pub. No.: US 2004/0120721 A1
(43) Pub. Date: Jun. 24, 2004

(54) Wavelength stabilizing control device and method thereof

(76) Inventors: Jen-Chih Wang, Taipei (TW); Sean Chang, Taoyuan (TW)

Correspondence Address: LAW OFFICES OF DAVID PAI, 1001 FOURTH AVENUE, SUITE 3200, SEATTLE, WA, 98154, US

(21) Appl. No.: 10/664,015

(22) Filed: Sep. 16, 2003

(30) Foreign Application Priority Data
Dec. 20, 2002 (TW) 91137006

(51) Int. Cl. H04B 10/04

(52) U.S. Cl. 398/195

(57) ABSTRACT

A wavelength stabilization control device for controlling a light-wave output by a tunable component in an optical communication system, including a beam splitting component, a first photo-detecting component, a second photo-detecting component, a Fabry-Perot Etalon and an optical filtering component. The beam splitting component splits the light-wave into a first light-wave and a second light-wave. The first photo-detecting component receives the first light-wave and transforms the first light-wave into a first electric signal. The second photo-detecting component receives the second light-wave and transforms the second light-wave into a second electric signal. The Fabry-Perot Etalon is provided between the beam splitting component and the second photo-detecting component for separating a light-wave including a specific wavelength from the second light-wave. The optical filtering component is provided between the Fabry-Perot Etalon and the second photo-detecting component for filtering a part of channels out from the light-wave including the specific wavelength.

### BACKGROUND OF THE INVENTION

1. Field of the Invention

The invention relates to a wavelength stabilization control device and the control method thereof, and in particular, to a wavelength stabilization control device that precisely locates the light-wave of a specific wavelength output by a tunable component on the correct channels in an optical communication system and the control method thereof.

2. Description of the Related Art

In an optical communication system, one ordinarily skilled in the art often uses a tunable component such as a tunable laser light source to enhance the transmission efficiency of optical signals, and thus to obtain a channel with a specific wavelength to carry the optical signal to be transmitted. However, since a channel of the actual wavelength obtained may deviate from the standard channel with an expected wavelength, a wavelength stabilization controller is often used to servo control the light-wave output by the tunable component. For instance, U.S. Pat. No. 4,583,228 and U.S. Pat. No. 6,400,739B1 disclosed the related technology.

FIG. 1 is a schematic diagram showing the configuration of a wavelength stabilization controller 3 in a tunable laser system 10. As shown in FIG. 1, the light-wave 5 output by a laser light source 1 is split into two parts. One part is received directly by a fiber channel 2, and the other part is first received by the wavelength stabilization controller 3 and then tuned via the servo control of the wavelength stabilization controller 3 and a control unit 4. In the wavelength stabilization controller 3, the light-wave 5 is split into two parts by a beam splitter 311. One part is conducted into a photo detector 314, and the other part is conducted into another photo detector 313 through a Fabry-Perot Etalon 312. Then, the light-wave received by the photo detector 313 and 314 are transformed into electric signals. These electric signals are processed by a signal processing and correcting device 315. The signal processing and correcting device 315 then outputs a control signal to the control unit 4.

The conventional wavelength stabilization controller has some disadvantages in the practical application. As for the technique disclosed in U.S. Pat. No. 4,583,228, since the channel of the output light-wave cannot be controlled precisely, the wavelength thereof after servo control may still lie in a wrong channel. Furthermore, as for the technique disclosed in U.S. Pat. No. 6,400,739B1, although two sets of rotatable optical filters are used to filter light, it suffers from low reliability because the rotatable optical filters have the disadvantages of being hard to position, easy to wear, and operationally limited in coordinating with each other.

### BRIEF SUMMARY OF THE INVENTION

In view of the above problems, an objective of the invention is to provide a wavelength stabilization control device to output a light-wave with a specific wavelength precisely on a correct channel and to facilitate its manufacture.

Another objective of the invention is to provide a wavelength stabilization control method to monitor the light-wave output by a tunable component to ensure that a specific wavelength lies on the correct channel.

The wavelength stabilization control device according to a first aspect of the invention is used for controlling a light-wave output by a tunable component in an optical communication system. It includes a beam splitting component, a first photo-detecting component, a second photo-detecting component, a Fabry-Perot Etalon and an optical filtering component. The beam splitting component splits the light-wave into a first light-wave and a second light-wave. The first photo-detecting component receives the first light-wave and transforms it into a first electric signal. The second photo-detecting component receives the second light-wave and transforms it into a second electric signal. The Fabry-Perot Etalon is provided between the beam splitting component and the second photo-detecting component for separating a light-wave including a specific wavelength from the second light-wave. The optical filtering component is provided between the Fabry-Perot Etalon and the second photo-detecting component for filtering a part of channels out from the light-wave including the specific wavelength.

The wavelength stabilization control device according to another aspect of the invention is used for controlling a light-wave output by a tunable component in an optical communication system. It includes a first beam splitting component, a first photo-detecting component, a second beam splitting component, a second photo-detecting component, a third photo-detecting component, an optical filtering component, and a Fabry-Perot Etalon. The first beam splitting component splits the light-wave into a first light-wave and a second light-wave. The first photo-detecting component receives the first light-wave and transforms the first light-wave into a first electric signal. The second beam splitting component splits the second light-wave into a third light-wave and a fourth light-wave. The second photo-detecting component receives the third light-wave after it passes through the optical filtering component and transforms the third light-wave into a second electric signal. The third photo-detecting component receives the fourth light-wave after it passes through the Fabry-Perot Etalon and transforms the fourth light-wave into a third electric signal. The optical filtering component is provided between the second beam splitting component and the second photo-detecting component for transforming a light-wave spectrum of the third light-wave covering the whole wavelength tuning range of the tunable component into a light-wave spectrum having a non-zero slope. The Fabry-Perot Etalon is provided between the second beam splitting component and the third photo-detecting component for separating a light-wave including a specific wavelength from the fourth light-wave.

The wavelength stabilization control method according to the first aspect of the invention includes the following steps: splitting the light-wave from a tunable component into a first light-wave and a second light-wave; separating a light-wave including a specific wavelength from the second light-wave; filtering out a part of channels from the light-wave including the specific wavelength and establishing a reference channel; transforming the first light-wave and the light-wave including the specific wavelength into electric signals, respectively; and performing a signal processing of the electric signals.

The wavelength stabilization control method according to the second aspect of the invention includes the following steps: splitting the light-wave from a tunable component into a first light-wave and a second light-wave; splitting the second light-wave into a third light-wave and a fourth light-wave; transforming the spectrum of the third light-wave into a spectrum having a non-zero slope; separating a light-wave including a specific wavelength from the fourth light-wave; transforming the first light-wave, the third light-wave having the spectrum of a non-zero slope, and the light-wave including the specific wavelength into electric signals, respectively; and performing a signal processing of the electric signals.

Comparing with the prior-art techniques, the invention ensures that a fiber channel receive a light-wave with a specific wavelength precisely on a correct channel without using movable optical components. Therefore, the invention does not suffer from the problems of positioning and wearing. In other words, it has improved reliability and reproducibility.

### BRIEF DESCRIPTION OF THE DRAWINGS

FIG. 1 is a schematic diagram showing the configuration of a conventional wavelength stabilization controller.

FIG. 2 is a schematic diagram showing the configuration of the wavelength stabilization control device according to a first aspect of the invention.

FIG. 3A is a diagram showing the spectrum of a high-pass edge filter in the wavelength stabilization control device according to the first embodiment of the invention.

FIG. 3B is a diagram showing the spectrum of the light-wave after passing through the Fabry-Perot Etalon in the wavelength stabilization control device according to the first embodiment of the invention.

FIG. 3C is a diagram showing the spectrum of the light-wave after passing through the Fabry-Perot Etalon and the high-pass edge filter in the wavelength stabilization control device according to the first embodiment of the invention.

FIG. 4A is a diagram showing the spectrum of a low-pass edge filter in the wavelength stabilization control device according to the second embodiment of the invention.

FIG. 4B is a diagram showing the spectrum of the light-wave after passing through the Fabry-Perot Etalon in the wavelength stabilization control device according to the second embodiment of the invention.

FIG. 4C is a diagram showing the spectrum of the light-wave after passing through the Fabry-Perot Etalon and the low-pass edge filter in the wavelength stabilization control device according to the second embodiment of the invention.

FIG. 5A is a diagram showing the spectrum of a band-pass edge filter in the wavelength stabilization control device according to the third embodiment of the invention.

FIG. 5B is a diagram showing the spectrum of the light-wave after passing through the Fabry-Perot Etalon in the wavelength stabilization control device according to the third embodiment of the invention.

FIG. 5C is a diagram showing the spectrum of the light-wave after passing through a band-pass edge filter and the Fabry-Perot Etalon in the wavelength stabilization control device according to the third embodiment of the invention.

FIG. 6 is a schematic diagram showing the configuration of the wavelength stabilization control device according to the second aspect of the invention.

FIG. 7A is a diagram showing the spectrum of a high-pass edge filter serving as the optical filtering component in the wavelength stabilization control device according to the fourth embodiment of the invention.

FIG. 7B is a diagram showing the spectrum of the light-wave after passing through the Fabry-Perot Etalon in the wavelength stabilization control device according to the fourth embodiment of the invention.

FIG. 7C is a diagram showing the strength of the signals of each channel modified by the servo component in the wavelength stabilization control device according to the fourth embodiment of the invention.

FIG. 8A is a diagram showing the spectrum of a low-pass edge filter serving as the optical filtering component in the wavelength stabilization control device according to the fourth embodiment of the invention.

FIG. 8B is a diagram showing the spectrum of the light-wave after passing through the Fabry-Perot Etalon in the wavelength stabilization control device according to the fourth embodiment of the invention.

FIG. 8C is a diagram showing the strength of the signals of each channel modified by the servo component in the wavelength stabilization control device according to the fourth embodiment of the invention.

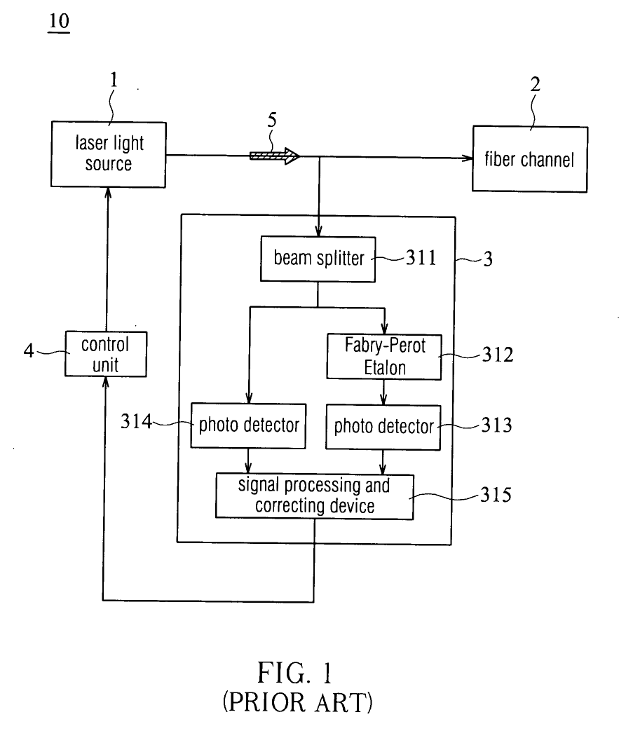

### DETAILED DESCRIPTION OF THE PREFERRED EMBODIMENTS

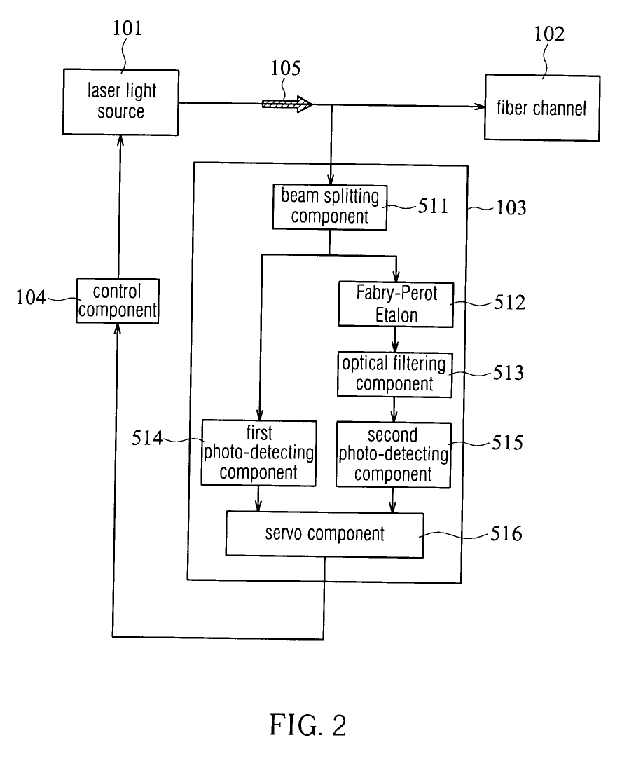

As shown in FIG. 2, the wavelength stabilization control device 103 includes a beam splitting component 511, a Fabry-Perot Etalon 512, an optical filtering component 513, a first photo-detecting component 514, a second photo-detecting component 515 and a servo component 516. The beam splitting component 511 may be any conventional beam splitter. The first photo-detecting component 514 and the second photo-detecting component 515 may be conventional photo-detectors. The servo component 516 may be a divider or a multiplier for processing electric signals.

The control procedure of the wavelength stabilization control device 103 according to the first aspect of the invention is described below. First, the light-wave 105 from tunable light source 101 that enters the wavelength stabilization control device 103 is split into two parts via the beam splitting component 511. One part of the light-wave is directly conducted to the first photo-detecting component 514 while the other part is conducted to the second photo-detecting component 515 after passing through the Fabry-Perot Etalon 512 and the optical filtering component 513. The light-wave received by the photo-detecting components 514 and 515 are transformed into electric signals via the servo component 516 and then output as a control signal to a control component 104 for controlling the tunable light source 101 using logical operations and signal processing.

It should be noted that the objective of providing the optical filtering component 513 is to filter a portion of the channels of the light-wave passing through the Fabry-Perot Etalon 512 to establish a reference channel and a reference wavelength. Thereby, the servo component 516 can control the tunable light source 101 according to the reference channel and the reference wavelength to ensure that a specific wavelength in the light-wave on a correct channel can be output precisely and be received by the fiber channel 102. Different optical filtering components are used in the embodiments according to the first aspect of the invention, which are described herein below.

<First Embodiment>

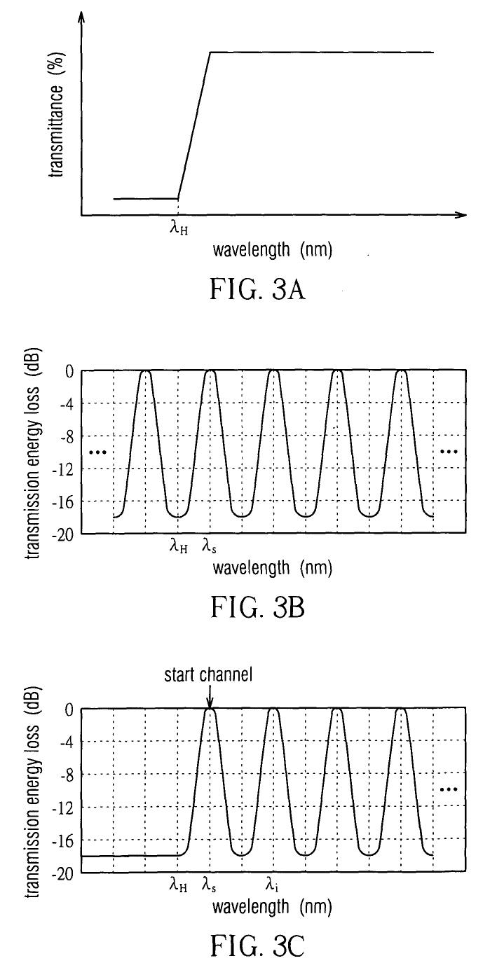

The wavelength stabilization control device according to the first embodiment of the invention is as shown in FIG. 2. The optical filtering component 513 is a high-pass edge filter whose spectrum is shown in FIG. 3A, and the spectrum of the light-wave after passing through the Fabry-Perot Etalon 512 is shown in FIG. 3B. The channels with wavelengths smaller than a cut-off wavelength λ_{H} among the light-wave passing through the Fabry-Perot Etalon 512 and the optical filtering component 513 are filtered out, and the resultant spectrum is shown in FIG. 3C. The horizontal axis shown in FIGS. 3A to 3C represents the wavelength distribution, and the vertical axis shown in FIGS. 3A to 3C represents the transmission energy loss expressed in dB or transmittance in percentage. When a specific wavelength λᵢ is expected to be output precisely, a light-wave including the specific wavelength λᵢ can be separated using the Fabry-Perot Etalon 512, and the channels having wavelengths smaller than the cut-off wavelength λ_{H} can be filtered out via the high-pass edge filter 513. Then, the wavelength in the light-wave channel nearest the cut-off wavelength λ_{H}, namely λ_{S} in FIG. 3C, can serve as the start point wavelength for servo control, and the channel with the start point wavelength can be treated as a start channel. Furthermore, the servo component 516 processes the electric signals from the photo-detecting components 514 and 515 and determines the intervals between the start channel and the expected channel. Thus, when the actual wavelength is different from the expected specific wavelength λᵢ, or when the channel is incorrect, the servo component 516 will determine the channel within which the specific wavelength is located according to the established start point wavelength and the start channel, and send its location to the control component 104 to ensure the output wavelength to be the specific wavelength λᵢ. For example, with respect to the ITU 100 GHZ specification, when the output light-wave 105 is expected to have a specific wavelength of 1550.12 nm, one can filter out parts of the channels using a high-pass edge filter 513 having a cut-off wavelength of 1540 nm. Here, the start channel is the channel having a central wavelength of 1540.56 nm. Thus, the servo component 516 can determine that the 13^{th} channel has the expected wavelength of 1550.12 nm, and control the tunable light source 101 to output precisely via the control component 104.

<Second Embodiment>

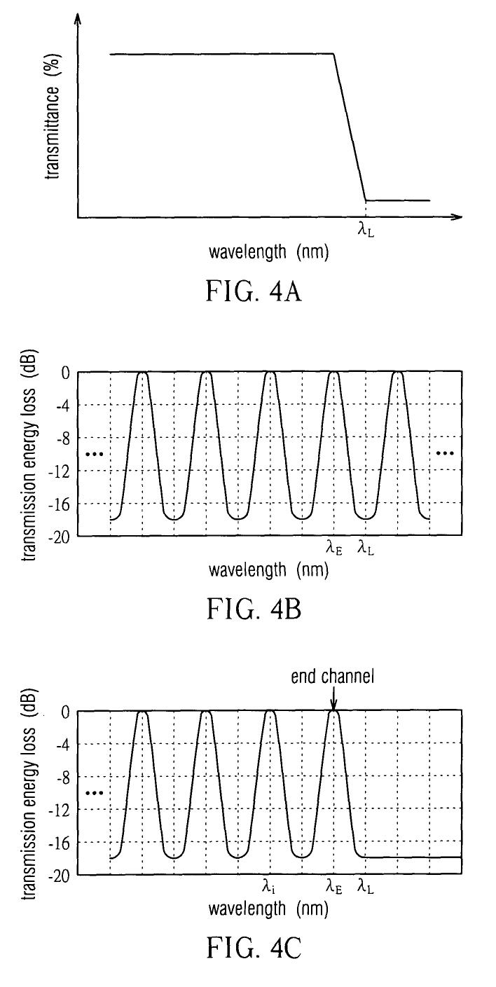

The wavelength stabilization control device according to the second embodiment of the invention is as shown in FIG. 2. In this embodiment, the optical filtering component 513 is a low-pass edge filter whose spectrum is shown in FIG. 4A, and the spectrum of the light-wave after passing through the Fabry-Perot Etalon 512 is shown in FIG. 4B. The channels with wavelengths larger than a cut-off wavelength λ_{L} among the light-wave passing through the Fabry-Perot Etalon 512 and the optical filtering component 513 are filtered out, and the resultant spectrum is shown in FIG. 4C. The horizontal axis shown in FIGS. 4A, 4B and 4C represents the wavelength distribution, and the vertical axis shown in FIGS. 4A, 4B and 4C represents the transmission energy loss expressed in dB or transmittance in percentage. When a specific wavelength A is expected to be output precisely, a light-wave including the specific wavelength λᵢ can be separated using the Fabry-Perot Etalon 512, and the channels having wavelengths larger than the cut-off wavelength λ_{L} can be filtered out using the low-pass edge filter 513. Then, the wavelength in the light-wave channel nearest the cut-off wavelength λ_{L}, namely λ_{E} in FIG. 4C, can serve as the end point wavelength for servo control, and the channel with the end point wavelength can be treated as an end channel. Furthermore, the servo component 516 processes the electric signals from the photo-detecting components 514 and 515 and determines the number of intervals between the end channel and the expected channel. Thus, when the actual wavelength is different from the expected specific wavelength λᵢ, or when the channel is incorrect, the servo component 516 will determine the channel within which the specific wavelength is located according to the established end point wavelength and the end channel, and send its location to the control component 104 to ensure the output wavelength to be the specific wavelength λᵢ. For example, with respect to the ITU 100 GHZ specification, when the output light-wave 105 is expected to have a specific wavelength of 1550.12 nm, one can filter out parts of the channels using a low-pass edge filter 513 having a cut-off wavelength of 1560 nm. Here, the end channel is the channel having a central wavelength of 1559.79 nm. Thus, the servo component 516 can determine that the 13^{th} channel from the end has the expected wavelength of 1550.12 nm, and control the tunable light source 101 to output precisely via the control component 104.

<Third Embodiment>

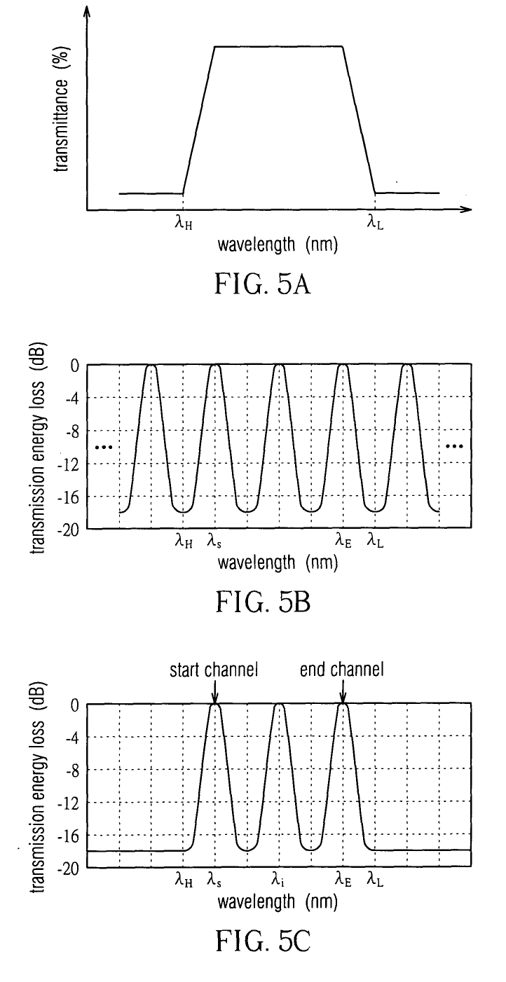

The wavelength stabilization control device according to the third embodiment of the invention is also as shown in FIG. 2. In this embodiment, the optical filtering component 513 is a band-pass edge filter whose spectrum is shown in FIG. 5A, and the spectrum of the light-wave after passing through the Fabry-Perot Etalon 512 is shown in FIG. 5B. The channels with wavelengths outside the range between λ_{H} and λ_{L} among the light-wave passing through the Fabry-Perot Etalon 512 and the optical filtering component 513 are filtered out, and the resultant spectrum is shown in FIG. 5C. The horizontal axis shown in FIGS. 5A to 5C represents the wavelength distribution, and the vertical axis shown in FIGS. 5A to 5C represents the transmission energy loss expressed in dB or transmittance in percentage. When a specific wavelength λᵢ is expected to be output precisely, a light-wave including the specific wavelength λᵢ can be separated using the Fabry-Perot Etalon 512, and the channels having wavelengths smaller than the wavelength λ_{H} or larger than λ_{L} can be filtered out using the band-pass edge filter 513. Then, the wavelengths in the light-wave channels nearest the cut-off wavelength λ_{H} and λ_{L}, namely λ_{S} and λ_{E} in FIG. 5C, can serve respectively as the start point wavelength and the end point wavelength for servo control, and the channel having the start point wavelength and the channel having the end point wavelength can be treated as the start channel and end channel, respectively. Furthermore, the servo component 516 processes the electric signals from the photo-detecting components 514 and 515 and determines the intervals between the expected channel and the start channel or the end channel. Thus, when the actual wavelength is different from the expected specific wavelength λᵢ, or when the channel is incorrect, the servo component 516 will determine the channel within which the specific wavelength is located according to the established start point wavelength, the end point wavelength, the start channel and the end channel, and send its location to the control component 104 to ensure the output wavelength to be the specific wavelength λᵢ. For example, with respect to the ITU 100 GHZ specification, when the output light-wave 105 is expected to have a specific wavelength of 1550.12 nm, one can filter out parts of the channels using a band-pass edge filter 513 having a wavelength range from 1540 nm to 1560 nm. Here, the start channel is the channel having a central wavelength of 1540.56 nm, and the end channel is the channel having a central wavelength of 1559.79 nm. Thus, the servo component 516 can determine the channel having the expected wavelength according to the start channel and end channel, and control the tunable light source 101 to output precisely via the control component 104.

It should be noted that in the embodiments described above, the high-pass, low-pass and band-pass filters are selected according to the actual requirements. Therefore, any type of optical filtering component could be implemented as long as the reference channel, the start channel and end channel, the reference wavelength, the start point wavelength, and the end point wavelength can be established.

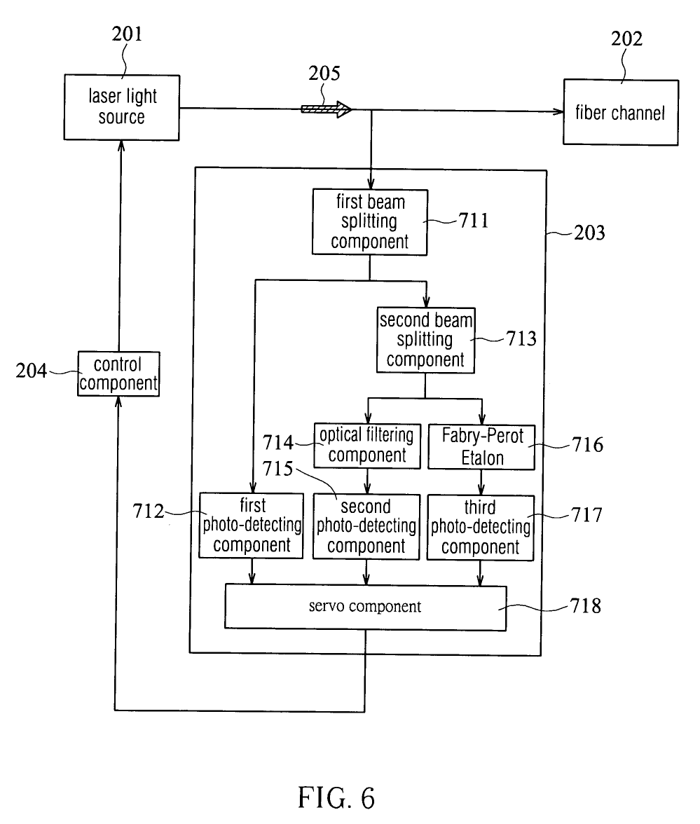

Furthermore, FIG. 6 shows the configuration of the wavelength stabilization control device according to the second aspect of the invention. The wavelength stabilization control device 203 according to the second aspect of the invention includes a first beam splitting component 711, a first photo-detecting component 712, a second beam splitting component 713, an optical filtering component 714, a second photo-detecting component 715, a Fabry-Perot Etalon 716, a third photo-detecting component 717 and a servo component 718. The beam splitting components 711 and 713 may be conventional beam splitters. The first photo-detecting component 712, the second photo-detecting component 715 and the third photo-detecting component 717 may be conventional photo-detectors. The servo component 718 may be a conventional signal processing and correcting device.

The control procedure of the wavelength stabilization control device 203 according to the second aspect will be described herein below. First, the light-wave 205 from tunable light source 201 entering the wavelength stabilization control device 203 is split into two parts via the first beam splitting component 711. One part of the light-wave is directly conducted to the first photo-detecting component 712, and the other part is further split into two parts via the second beam splitting component 713, wherein one part is conducted to the second photo-detecting component 715 through the optical filtering component 714, and the other part is conducted to the third photo-detecting component 717 through the Fabry-Perot Etalon 716. The servo component 718, functioning as a divider or a multiplier, then transforms the light-wave received by the photo-detecting components 712, 715 and 717 into electric signals, and outputs a control signal to a control component 204 to control the tunable light source 201 after logical operations and signal processing.

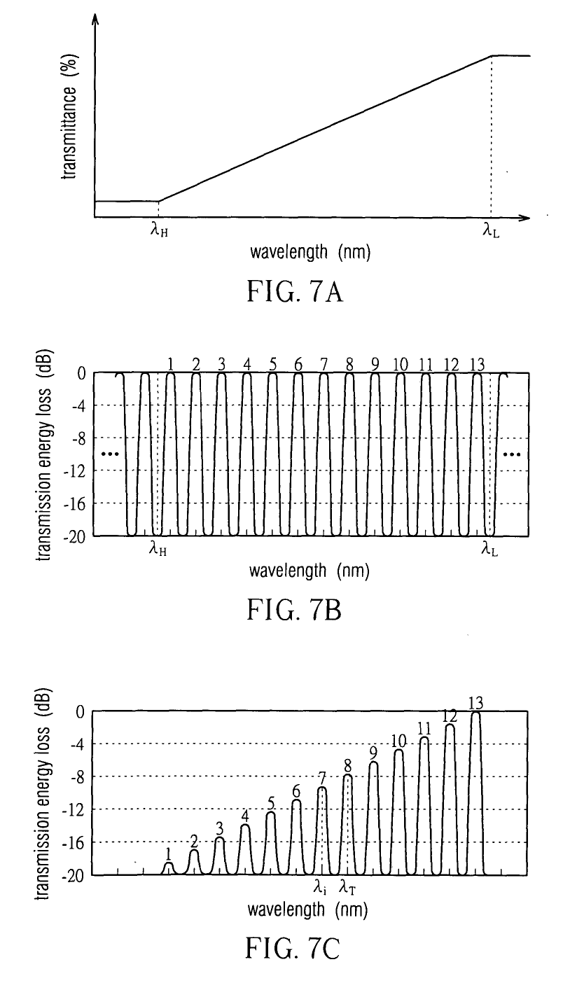

The optical filtering component 714 is provided to transform the spectrum of the light-wave passing through it into a spectrum as shown in FIG. 7C. Since the strength of the signal is different for each channel, the servo component 718, functioning as a divider or a multiplier, processes the signals from the photo detecting components 712,715 and 717 to modify the signal strength of each channel as shown in FIG. 7C. Accordingly, it is ensured that a specific wavelength in the light-wave on a correct channel can be output precisely by the laser light source 201 and be received by the fiber channel 102. The wavelength stabilization control device according to the second aspect of the invention is described herein below in terms of embodiments.

<Fourth Embodiment>

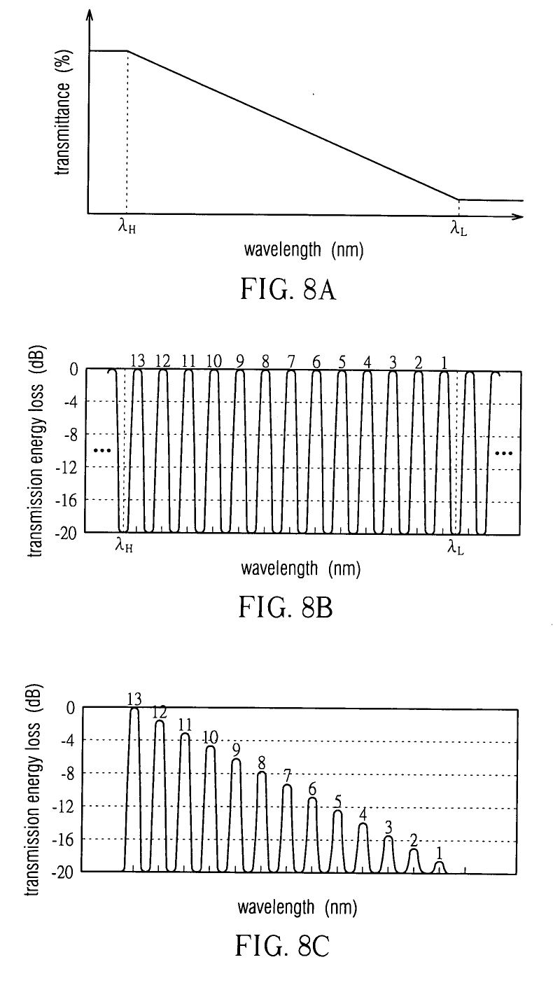

The configuration of the wavelength stabilization control device according to the fourth embodiment of the invention is shown in FIG. 6. In this embodiment, the optical filtering component 714 is a high-pass edge filter that filters out the channels with wavelengths smaller than the whole tuning range of the tunable light source 201, and the film coated on the optical filter makes the strength of the light-wave passed to have a linear relationship with its corresponding wavelength. The spectrum of the optical filtering component 714 is shown in FIG. 7A. The spectrum of the light-wave after passing through the Fabry-Perot Etalon 716 is shown in FIG. 7B. Furthermore, the strength of the signals of each channel modified by the servo component 718 is shown in FIG. 7C. The horizontal axis shown in FIGS. 7A, 7B and 7C represents the wavelength distribution, and the vertical axis shown in FIGS. 7A, 7B and 7C represents the transmission energy loss expressed in dB or the transmittance in percentage. When a specific wavelength λᵢ is expected to be output precisely, the high-pass edge filter can be used as the optical filtering component 714 to distinguish each channel, and the channel with the expected wavelength can be determined by comparing the light-wave passing through the Fabry-Perot Etalon 716 with the light-wave of each channel. Thus, when the actual output wavelength (such as the λ_{T} shown in FIG. 7C) is different from the expected specific wavelength λᵢ, or when the channel is incorrect, the servo component 718 informs the control component 204 of the correct channel location (such as the 7^{th} channel shown in FIG. 7C) to ensure the output wavelength to be the specific wavelength λᵢ. Of course, the optical filtering component 714 may be a low-pass edge filter with a spectrum shown in FIG. 8A. Under such circumstances, the optical filtering component 714 filters out the channels with wavelengths larger than the whole tuning range of the passing light wave. The spectrum of the light-wave after passing through the Fabry-Perot Etalon 716 according to this embodiment is shown in FIG. 8B. The strength of the signals modified by the servo component 718 is shown in FIG. 8C. Therefore, the channel of the specific wavelength can be found by examining the transmission energy of each channel from the lowest to the highest. The detailed description is omitted here for the purpose of brevity.

While the invention has been described by way of examples and in terms of embodiments, it is to be understood that the invention is not limited to the disclosed embodiments, and is intended to cover various modifications. Therefore, the scope of the appended claims should be accorded the broadest interpretation so as to encompass all such modifications.

What is claimed is:

1. A wavelength stabilization control device for controlling a light-wave output by a tunable component in an optical communication system, comprising:
a beam splitting component for splitting the light-wave into a first light-wave and a second light-wave;
a first photo-detecting component for receiving the first light-wave and transforming the first light-wave into a first electric signal;
a second photo-detecting component for receiving the second light-wave and transforming the second light-wave into a second electric signal;
a Fabry-Perot Etalon provided between the beam splitting component and the second photo-detecting component for separating a light-wave including a specific wavelength from the second light-wave; and
an optical filtering component provided between the Fabry-Perot Etalon and the second photo-detecting component for filtering a part of channels of the light-wave including the specific wavelength.

2. The wavelength stabilization control device according to claim 1, further comprising:
a servo component for receiving the first electric signal and the second electric signal and performing signal processing.

3. The wavelength stabilization control device according to claim 1, wherein the tunable component is a tunable laser light source.

4. The wavelength stabilization control device according to claim 1, wherein the beam splitting component is a beam splitter.

5. The wavelength stabilization control device according to claim 1, wherein the optical filtering component is a high-pass edge filter.

6. The wavelength stabilization control device according to claim 1, wherein the optical filtering component is a low-pass edge filter.

7. The wavelength stabilization control device according to claim 1, wherein the optical filtering component is a band-pass edge filter.

8. A wavelength stabilization control device for controlling a light-wave output by a tunable component in an optical communication system, comprising:
a first beam splitting component for splitting the light-wave into a first light-wave and a second light-wave;
a first photo-detecting component for receiving the first light-wave and transforming the first light-wave into a first electric signal;
a second beam splitting component for splitting the second light-wave into a third light-wave and a fourth light-wave;
a second photo-detecting component for receiving the third light-wave and transforming the third light-wave into a second electric signal;
a third photo-detecting component for receiving the fourth light-wave and transforming the fourth light-wave into a third electric signal;
an optical filtering component provided between the second beam splitting component and the second photo-detecting component for transforming the light-wave spectrum of the third light-wave covering the whole wavelength tuning range of the tunable component into a light-wave spectrum having a non-zero slope; and
a Fabry-Perot Etalon provided between the second beam splitting component and the third photo-detecting component for separating a light-wave including a specific wavelength from the fourth light-wave.

9. The wavelength stabilization control device according to claim 8, further comprising:
a servo component for receiving the first electric signal, the second electric signal and the third electric signal to perform signal processing.

10. The wavelength stabilization control device according to claim 8, wherein the tunable component is a tunable laser light source.

11. The wavelength stabilization control device according to claim 8, wherein the first beam splitting component and second beam splitting component are beam splitters.

12. The wavelength stabilization control device according to claim 8, wherein the optical filtering component is a high-pass edge filter.

13. The wavelength stabilization control device according to claim 8, wherein the optical filtering component is a low-pass edge filter.

14. A wavelength stabilization control method, comprising the steps of:
splitting the light-wave from a tunable component into a first light-wave and a second light-wave;
separating a light-wave including a specific wavelength from the second light-wave;
filtering out a part of channels from the light-wave including the specific wavelength and establishing a reference channel;
transforming the first light-wave and the light-wave including the specific wavelength into electric signals, respectively; and
performing a signal processing to the electric signals.

15. The wavelength stabilization control method according to claim 14, wherein the filtering step is accomplished by using a high-pass edge filter with a cut-off wavelength λ_{H} to filter out channels with wavelengths smaller than λ_{H}, and using the channel with center wavelength nearest the cut-off wavelength λ_{H} as a start channel.

16. The wavelength stabilization control method according to claim 14, wherein the filtering step is accomplished by using a low-pass edge filter with a cut-off wavelength λ_{L} to filter out channels with wavelengths larger than λ_{L}, and using the channel with center wavelength nearest the cut-off wavelength λ_{L} as an end channel.

17. The wavelength stabilization control method according to claim 14, wherein the filtering step is accomplished by using a band-pass edge filter which has a range from λ_{H} to λ_{L} to filter out channels with wavelengths outside the range, and using the channels with center wavelength nearest λ_{H} and λ_{L} as a start channel and an end channel, respectively.

18. A wavelength stabilization control method, comprising the steps of:
splitting the light-wave from a tunable component into a first light-wave and a second light-wave;
splitting the second light-wave into a third light-wave and a fourth light-wave;
transforming the spectrum of the third light-wave into a spectrum having a non-zero slope;
separating a light-wave including a specific wavelength from the fourth light-wave;
transforming the first light-wave, the third light-wave having the spectrum of a non-zero slope, and the light-wave including the specific wavelength into electric signals, respectively; and
performing a signal processing for the electric signals.

19. The wavelength stabilization control method according to claim 18, wherein the spectrum transforming step is accomplished by passing the third light-wave through a high-pass edge filter covering the whole wavelength tuning range of the tunable component.

20. The wavelength stabilization control method according to claim 18, wherein the spectrum transforming step is accomplished by passing the third light-wave through a low-pass edge filter covering the whole wavelength tuning range of the tunable component.
